(19) United States
(12) Patent Application Publication
(10) Pub. No.: US 2024/0418290 A1
(43) Pub. Date: Dec. 19, 2024

(54) ACTUATOR AND VALVE DEVICE

(71) Applicant: FUJIKIN INCORPORATED, Osaka (JP)

(72) Inventors: Nobuo NAKAMURA, Osaka (JP); Kazunari WATANABE, Osaka (JP); Tomohiro NAKATA, Osaka (JP); Tsutomu SHINOHARA, Osaka (JP)

(21) Appl. No.: 18/815,030

(22) Filed: Aug. 26, 2024

Related U.S. Application Data
(63) Continuation of application No. PCT/JP2022/048444, filed on Dec. 28, 2022.

(30) Foreign Application Priority Data
Feb. 28, 2022 (JP) 2022-029525

(51) Int. Cl. F16K 31/122

(52) U.S. Cl. CPC F16K 31/122

(57) ABSTRACT

An actuator includes: a casing including a first pressing portion; a drive member including a second pressing portion, the drive member being driven by an operating fluid flowing from outside; and a sealing member disposed to be sandwiched between the casing and the drive member in a direction perpendicular to a moving direction of the drive member, the sealing member sealing a pressure chamber. The first pressing portion and the second pressing portion face each other in the moving direction of the drive member. The sealing member is positioned between the first pressing portion and the second pressing portion. The second pressing portion moves toward and away from the first pressing portion as the drive member moves, and when the second pressing portion is positioned close to the first pressing portion, the sealing member is configured to be sandwiched between the first pressing portion and the second pressing portion.

### CROSS REFERENCE TO RELATED APPLICATION

This application is a continuation application under 35 U.S.C. § 120 of No. PCT/JP2022/048444, filed Dec. 28, 2022, which is incorporated herein by reference, and which claimed priority to Japanese Application No. 2022-029525, filed Feb. 28, 2022. The present application likewise claims priority under 35 U.S.C. § 119 to Japanese Application No. 2022-029525, filed Feb. 28, 2022, the entire content of which is also incorporated herein by reference.

### TECHNICAL FIELD

The present disclosure relates to an actuator and a valve device for use in semiconductor manufacturing equipment and the like.

### BACKGROUND

In the valve device disclosed in Japanese Patent No. 6170635, which is opened and closed by an operating fluid, an O-ring is provided between a piston and a partition in order to maintain a sealing property of a pressure chamber.

### SUMMARY

However, in the valve device of Japanese Patent No. 6170635, since the sealing property of the O-ring is generated only in a direction perpendicular to the vertical direction, when the valve device is used in a high-temperature environment for a long period of time, lubricating oil evaporates, the O-ring is degraded due to heat, and the O-ring is worn due to sliding, and accordingly the sealing property of the O-ring deteriorates.

Therefore, one of the objects of the present disclosure is to provide an actuator and a valve device capable of suppressing the deterioration in the sealing property of a sealing member even if used in a high-temperature environment for a long period of time.

An actuator according to one or more embodiments of the present disclosure includes a casing including a first pressing portion; a drive member including a second pressing portion, the drive member being provided in the casing, the drive member forming a pressure chamber along with the casing, the drive member being driven by an operating fluid flowing from outside; and a sealing member disposed to be sandwiched between the casing and the drive member in a direction perpendicular to a moving direction of the drive member, the sealing member having a ring-shape and sealing the pressure chamber. The first pressing portion and the second pressing portion face each other in the moving direction of the drive member. The sealing member is positioned between the first pressing portion and the second pressing portion. The second pressing portion moves toward and away from the first pressing portion as the drive member moves, and when the second pressing portion is positioned close to the first pressing portion, the sealing member is configured to be sandwiched between the first pressing portion and the second pressing portion.

A valve device according to one or more embodiments of the present disclosure includes a body having a flowing passage; and the above actuator attached to the body and configured to open and close the flowing passage.

### BRIEF DESCRIPTION OF THE DRAWINGS

In the drawings:

FIG. 1 is a partial cross-sectional view of a valve device in a closed state according to one embodiment.

FIG. 2 is a partial cross-sectional view of the valve device in an open state.

FIG. 3A is an enlarged view of one portion of the valve device shown in FIG. 1, surrounded by a dotted line L1, and FIG. 3B is an enlarged view of one portion of the valve device shown in FIG. 2, surrounded by a dotted line L2.

### DETAILED DESCRIPTION

The valve device according to one embodiment in the present disclosure will be described with reference to the drawings.

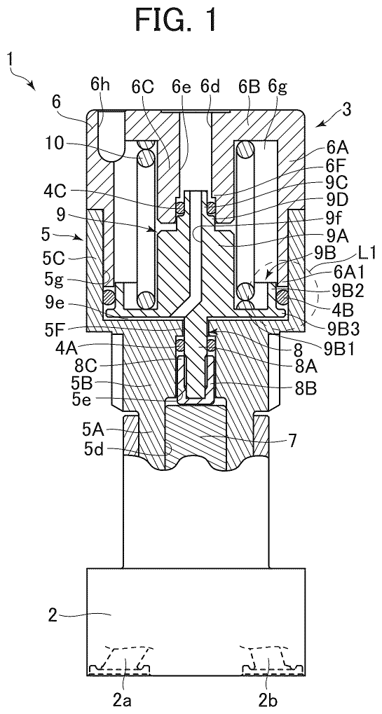

FIG. 1 shows a partial cross-sectional view of a valve device 1 in a closed state according to the present embodiment. The valve device 1 according to the present embodiment is a diaphragm valve device.

The valve device 1 is, for example, a diaphragm valve device, and includes a body 2 and an actuator 3. In the description below, the side of the actuator 3 in the valve device 1 is designated as an upper side, while the side of the body 2 in the valve device 1 is designated as a lower side.

The body 2 has an inflow passage 2a, an outflow passage 2b, and a valve chamber not illustrated, and the valve chamber not illustrated is equipped with a diaphragm serving as a valve element.

The actuator 3 includes a bonnet 5, an actuator cap 6, a diaphragm retainer 7, a stem 8, a piston 9, a compression coil spring 10, and O-rings 4A to 4C.

The bonnet 5 has a substantially cylindrical shape, and has a lower portion 5A, an intermediate portion 5B, and an upper portion 5C. The bonnet 5 is fixed to the body 2 by inserting the lower portion 5A into the body 2 and screwing the lower portion 5A into the body 2. The lower portion 5A has a first through hole 5d.

The intermediate portion 5B is positioned on an upper side of the lower portion 5A, and the intermediate portion 5B has a hexagonal prismatic shape. The intermediate portion 5B has a second through hole 5e. An inner diameter of the second through hole 5e is smaller than an inner diameter of the first through hole 5d. A protruding portion 5F extending inward into the second through hole 5e is provided at an upper end portion of the intermediate portion 5B. In the second through hole 5e, an inner diameter of the protruding portion 5F is smaller than an inner diameter of the remaining portion.

The upper portion 5C is positioned on an upper side of the intermediate portion 5B and is provided so as to extend outward beyond the intermediate portion 5B. The upper portion 5C has a third through hole 5g. An inner diameter of the third through hole 5g is larger than the inner diameters of the first through hole 5d and the second through hole 5e.

The actuator cap 6 has a substantially lidded cylindrical shape, and has an outer cylinder portion 6A, an upper lid portion 6B, and an inner cylinder portion 6C. The actuator cap 6 is fixed to the bonnet 5 by screwing a lower end portion of the outer cylinder portion 6A onto the upper portion 5C of the bonnet 5. A lower end portion 6A1 of the outer cylinder portion 6A is spaced apart from an upper surface of the intermediate portion 5B.

The upper lid portion 6B is provided so as to cover the upper end of the outer cylinder portion 6A. The upper lid portion 6B has a screw hole 6d into which a pipe fitting not illustrated is screwed. The inner cylinder portion 6C is connected to an inner end portion of the upper lid portion 6B. An axial length of the inner cylinder portion 6C is shorter than an axial length of the outer cylinder portion 6A. In other words, a lower end of the inner cylinder portion 6C is positioned above a lower end of the outer cylinder portion 6A.

The inner cylinder portion 6C has a fourth through hole 6e communicating with the screw hole 6d. A lower portion of the fourth through hole 6e is wider in diameter than an upper portion. In other words, the inner cylinder portion 6C has an inner step portion 6F on an inner peripheral surface thereof. In the fourth through hole 6e, a portion below the inner step portion 6F is wider in diameter than a portion above the inner step portion 6F.

The bonnet 5 and the actuator cap 6 form a housing space 6g which accommodates the piston 9 and the compression coil spring 10. An air hole 6h which communicates the outside and the housing space 6g is formed in the outer cylinder portion 6A and the upper lid portion 6B of the actuator cap 6. The bonnet 5 and the actuator cap 6 correspond to a casing of an actuator.

The diaphragm retainer 7 is provided on an upper side of the diaphragm not illustrated provided in the body 2 and is supported by the lower portion 5A of the bonnet 5 so as to be movable in the vertical direction.

The stem 8 is supported by the intermediate portion 5B of the bonnet 5 so as to be movable in the vertical direction and is configured to open and close the inflow passage 2a and the outflow passage 2b by moving toward and away from the diaphragm not illustrated. The stem 8 has a columnar portion 8A and a stem lower portion 8B. The columnar portion 8A extends throughout an entire vertical length of the intermediate portion 5B. The stem lower portion 8B has a bottomed columnar shape and is fixed to the columnar portion 8A by screwing an inner peripheral portion of the stem lower portion 8B onto a lower end portion of the columnar portion 8A. The stem lower portion 8B is provided so as to cover an outside of the lower end portion of the columnar portion 8A. An outer diameter of the stem lower portion 8B is slightly smaller than the inner diameter of the second through hole 5e. An upper end portion 8C of the stem lower portion 8B and the protruding portion 5F of the intermediate portion 5B face each other in the vertical direction (the moving direction of the piston 9).

The piston 9 is configured integrally with the stem 8 and provided on an upper side of the stem 8, and is supported by the bonnet 5 and the actuator cap 6 so as to be movable in the vertical direction. The piston 9 has a base 9A, a lateral protruding portion 9B, and an upper protruding portion 9C. The base 9A has a substantially cylindrical shape, and is configured integrally with the stem 8 on a lower surface. The stem 8 and the piston 9 correspond to a drive member.

The lateral protruding portion 9B has a circular, substantially dish-like shape, and protrudes in a direction perpendicular to an axis of the base 9A from a lower end portion of the base 9A. The lateral protruding portion 9B has a bottom portion 9B1 and a side wall portion 9B2. The bottom portion 9B1 has a disk shape and is provided so as to radially spread from the base 9A toward the upper portion 5C. The side wall portion 9B2 has a ring shape and is provided inside an outer end portion 9B3 of the bottom portion 9B1. The outer end portion 9B3 of the bottom portion 9B1 and the lower end portion 6A1 of the outer cylinder portion 6A face each other in the vertical direction (the moving direction of the piston 9). An end surface of the outer end portion 9B3 is spaced apart from an inner peripheral surface of the upper portion 5C.

The upper protruding portion 9C has a substantially cylindrical shape and protrudes upward from an upper surface of the base 9A. An upper portion of the upper protruding portion 9C is smaller in diameter than a lower portion of the upper protruding portion 9C. In other words, the upper protruding portion 9C has an outer step portion 9D on an outer peripheral surface thereof. The outer step portion 9D and the inner step portion 6F face each other in the vertical direction (the moving direction of the piston 9).

A lower surface of the bottom portion 9B1 of the piston 9 and an upper surface of the intermediate portion 5B of the bonnet 5 define a pressure chamber 9e. The base 9A and the upper protruding portion 9C of the piston 9 have an operating fluid inlet passage 9f extending from an upper end thereof to the pressure chamber 9e.

The compression coil spring 10 is disposed between a lower surface of the upper lid portion 6B of the actuator cap 6 and an upper surface of the bottom portion 9B1 of the piston 9, and constantly biases the piston 9 downward.

The O-ring 4A is disposed so as to be sandwiched between the intermediate portion 5B of the bonnet 5 and the stem 8 in a direction perpendicular to the vertical direction and is positioned between the protruding portion 5F of the intermediate portion 5B and the upper end portion 8C of the stem lower portion 8B. The O-ring 4B is disposed so as to be sandwiched between the upper portion 5C of the bonnet 5 and the side wall portion 9B2 of the piston 9 in the direction perpendicular to the vertical direction and is positioned between the lower end portion 6A1 of the outer cylinder portion 6A and the outer end portion 9B3 of the bottom portion 9B1. The O-ring 4C is disposed so as to be sandwiched between the inner cylinder portion 6C of the actuator cap 6 and the upper protruding portion 9C of the piston 9 in the direction perpendicular to the vertical direction and is positioned between the inner step portion 6F of the inner cylinder portion 6C and the outer step portion 9D of the upper protruding portion 9C.

The O-rings 4A to 4C seal the pressure chamber 9e. The O-rings 4A to 4C correspond to ring-shaped sealing members, respectively. The protruding portion 5F of the intermediate portion 5B, the lower end portion 6A1 of the outer cylinder portion 6A, and the inner step portion 6F of the inner cylinder portion 6C correspond to first pressing portions, respectively. The upper end portion 8C of the stem lower portion 8B, the outer end portion 9B3 of the bottom portion 9B1, and the outer step portion 9D of the upper protruding portion 9C correspond to second pressing portions, respectively.

The opening and closing operation of the valve device 1 according to the present embodiment will be described, next.

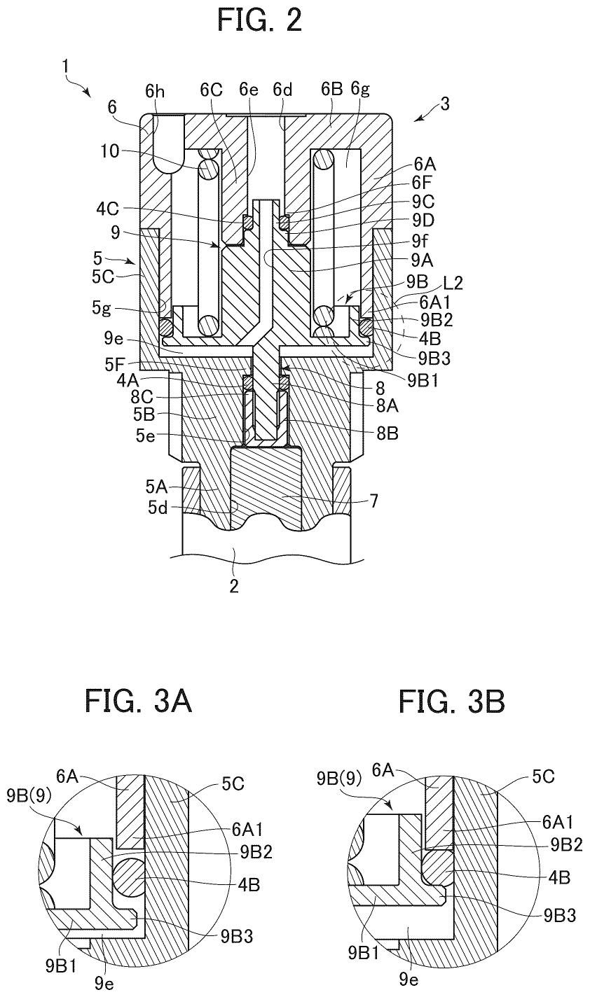

FIG. 2 is a partial cross-sectional view of the valve device 1 in an open state.

As shown in FIG. 1, in the valve device 1 in the closed state, no operating fluid flows into the pressure chamber 9e, the stem 8 and the piston 9 are at a bottom dead center (positioned closer to the body 2), due to the biasing force of the compression coil spring 10, and the diaphragm not illustrated is pressed by the diaphragm retainer 7, and thereby the valve device 1 is in the closed state. In other words, in the normal state (the state where an operating fluid is not supplied), the valve device 1 is in the closed state.

Next, the valve device 1 is brought into the state where an operating fluid flows from an operating fluid supply source not illustrated to the valve device 1. An operating fluid is thereby supplied to the valve device 1. The operating fluid flows into the pressure chamber 9e, via an air tube and a pipe fitting not illustrated, through the operating fluid inlet passage 9f. When the operating fluid flows into the pressure chamber 9e, the piston 9 rises against the biasing force of the compression coil spring 10. As shown in FIG. 2, the stem 8 thereby moves to a top dead center (to separate from the body 2), the diaphragm retainer 7 moves upward due to the elastic force of the diaphragm not illustrated and the pressure of the fluid (gas), and the inflow passage 2a and the outflow passage 2b communicate with each other, and thereby the valve 1 becomes in the open state.

In order to shift the valve device 1 from the open state to the closed state, a three-way valve device not illustrated is switched to allow the operating fluid to discharge from the actuator 3 of the valve device 1 to the outside. This discharges the operating fluid inside the pressure chamber 9e to the outside via the operating fluid inlet passage 9f. As a result, the stem 8 and the piston 9 move to the bottom dead center due to the biasing force of the compression coil spring 10, and thereby the valve device 1 becomes in the closed state (FIG. 1).

FIG. 3A is an enlarged view of one portion of the valve device 1 shown in FIG. 1, surrounded by the dotted line L1, and FIG. 3B is an enlarged view of one portion of the valve device 1 shown in FIG. 2, surrounded by the dotted line L2.

As shown in FIG. 3A, when the valve device 1 is in the closed state, the piston 9 is positioned at the bottom dead center, and the distance between the lower end portion 6A1 of the outer cylinder portion 6A and the outer end portion 9B3 of the bottom portion 9B1 is larger than the vertical width (wire diameter) of the O-ring 4B. In other words, the lower end portion 6A1 of the outer cylinder portion 6A and the outer end portion 9B3 of the bottom portion 9B1 are spaced apart from the O-ring 4B, respectively.

As shown in FIG. 3B, when the valve device 1 is in the open state, the piston 9 is positioned at the top dead center, and the distance between the lower end portion 6A1 of the outer cylinder portion 6A and the outer end portion 9B3 of the bottom portion 9B1 is smaller than the vertical width (wire diameter) of the O-ring 4B. In other words, the lower end portion 6A1 of the outer cylinder portion 6A and the outer end portion 9B3 of the bottom portion 9B1 are in contact with the O-ring 4B and press against the O-ring 4B, respectively.

Accordingly, even if lubricating oil evaporates, the O-ring 4B is degraded due to heat, and the O-ring 4B is worn due to sliding when the valve device 1 is used in a high-temperature environment for a long period of time, the O-ring 4B is sandwiched between the lower end portion 6A1 of the outer cylinder portion 6A and the outer end portion 9B3 of the bottom portion 9B1 when the pressure chamber 9e is supplied with the operating fluid. As a result, the O-ring 4B is deformed in the direction perpendicular to the vertical direction due to the elasticity, thereby suppressing the deterioration in the sealing property of the O-ring 4B.

As shown in FIG. 1, when the valve device 1 is in the closed state, the piston 9 is positioned at the bottom dead center, the distance between the protruding portion 5F of the intermediate portion 5B and the upper end portion 8C of the stem lower portion 8B is larger than the vertical width (wire diameter) of the O-ring 4A, and the distance between the inner step portion 6F of the inner cylinder portion 6C and the outer step portion 9D of the upper protruding portion 9C is larger than the vertical width (wire diameter) of the O-ring 4C. In other words, the protruding portion 5F of the intermediate portion 5B and the upper end portion 8C of the stem lower portion 8B are spaced apart from the O-ring 4A, respectively, and the inner step portion 6F of the inner cylinder portion 6C and the outer step portion 9D of the upper protruding portion 9C are spaced apart from the O-ring 4C, respectively.

As shown in FIG. 2, when the valve device 1 is in the open state, the piston 9 is positioned at the top dead center, the distance between the protruding portion 5F of the intermediate portion 5B and the upper end portion 8C of the stem lower portion 8B is smaller than the vertical width (wire diameter) of the O-ring 4A, and the distance between the inner step portion 6F of the inner cylinder portion 6C and the outer step portion 9D of the upper protruding portion 9C is smaller than the vertical width (wire diameter) of the O-ring 4C. In other words, the protruding portion 5F of the intermediate portion 5B and the upper end portion 8C of the stem lower portion 8B are in contact with the O-ring 4A and press against the O-ring 4A, respectively, while the inner step portion 6F of the inner cylinder portion 6C and the outer step portion 9D of the upper protruding portion 9C are in contact with the O-ring 4C and press against the O-ring 4C, respectively.

Accordingly, when the pressure chamber 9e is supplied with the operating fluid, the O-ring 4A is sandwiched between the protruding portion 5F of the intermediate portion 5B and the upper end portion 8C of the stem lower portion 8B, while the O-ring 4C is sandwiched between the inner step portion 6F of the inner cylinder portion 6C and the outer step portion 9D of the upper protruding portion 9C. As a result, the O-rings 4A, 4C are deformed in the direction perpendicular to the vertical direction due to the elasticity, thereby suppressing the deterioration in the sealing properties of the O-rings 4A, 4C.

As shown in FIG. 3B, the pressure of the operating fluid is applied upward to the O-ring 4B under the state where the O-ring 4B is sandwiched between the lower end portion 6A1 of the outer cylinder portion 6A and the outer end portion 9B3 of the bottom portion 9B1. The O-ring 4B is deformed in the direction perpendicular to the vertical direction due to the elasticity also when subjected to the pressure of the operating fluid as described above, thereby further suppressing the deterioration in the sealing property of the O-ring 4B.

The upper portion of the O-ring 4B is pressed by the lower end portion 6A1 of the outer cylinder portion 6A of the actuator cap 6. As described above, the existing configuration allows the O-ring 4B to be pressed, and accordingly the actuator 3 in the present embodiment is easily provided.

The present disclosure is not limited to the above-described embodiment. A person skilled in the art may make various additions and changes within the scope of the present disclosure.

For example, the stem lower portion 8B, which is screwed and connected to the columnar portion 8A in the above-described embodiment, may be connected by fitting, or may be connected using a C-ring. Alternatively, the stem lower portion 8B may be connected to the cylindrical portion 8A using welding or set screws.

What is claimed is:

1. An actuator comprising:
a casing including a first pressing portion;
a drive member including a second pressing portion, the drive member being provided in the casing, the drive member forming a pressure chamber along with the casing, the drive member being driven by an operating fluid flowing from outside; and
a sealing member disposed to be sandwiched between the casing and the drive member in a direction perpendicular to a moving direction of the drive member, the sealing member having a ring-shape and sealing the pressure chamber,
wherein the first pressing portion and the second pressing portion face each other in the moving direction of the drive member,
the sealing member is positioned between the first pressing portion and the second pressing portion, and
the second pressing portion moves toward and away from the first pressing portion as the drive member moves, and when the second pressing portion is positioned close to the first pressing portion, the sealing member is configured to be sandwiched between the first pressing portion and the second pressing portion.

2. The actuator according to claim 1, wherein under a state where the second pressing portion is positioned close to the first pressing portion, and the sealing member is sandwiched between the first pressing portion and the second pressing portion, pressure of the operating fluid is applied to the sealing member.

3. The actuator according to claim 1, wherein
the drive member includes a piston,
the casing includes a bonnet and an actuator cap connected to the bonnet,
the sealing member is disposed to be sandwiched between the bonnet and the piston in a direction perpendicular to a moving direction of the piston,
an outer end portion of the piston functions as the second pressing portion,
an end portion of the actuator cap functions as the first pressing portion, and
the sealing member is configured to be sandwiched between the end portion of the actuator cap and the outer end portion of the piston.

4. A valve device comprising:
a body having a flowing passage; and
the actuator according to claim 1, the actuator attached to the body and configured to open and close the flowing passage.
